(19) United States
(12) Patent Application Publication
(10) Pub. No.: US 2006/0213334 A1
(43) Pub. Date: Sep. 28, 2006

(54) Ratchet mechanism for ratchet tools

(76) Inventor: Chang Chuan Lee, Nantou County (TW)

Correspondence Address: LEE CHANG CHUAN, P.O. BOX 2103, TAICHUNG, TW

(21) Appl. No.: 11/332,324

(22) Filed: Jan. 17, 2006

(30) Foreign Application Priority Data
Mar. 28, 2005 (TW) 094109663

(51) Int. Cl. B25B 13/46

(52) U.S. Cl. 81/63

(57) ABSTRACT

A ratchet mechanism for a ratchet tool includes a driving member having teeth defined in an outer periphery thereof and a driving stub. A pawl is located beside the driving member and has a toothed surface for being engaged with the teeth of the driving member. A selection member is connected to the pawl. A substantially U-shaped first spring member and a substantially U-shaped second spring member are respectively connected to the head and the pawl is enclosed and clamped between the left biasing portions and the right biasing portions of the first and second spring members.

### FIELD OF THE INVENTION

The present invention relates to a ratchet mechanism for ratchet tools and the mechanism includes biasing members for returning the pawl.

### BACKGROUND OF THE INVENTION

A conventional ratchet tool 7 is shown in FIG. 8 and generally includes a driving member 71 rotatably received in a hole of the head of the tool 7 and the driving member 71 includes teeth 72 defined in an outer periphery thereof and a driving stub 73 extending from therefrom so that workpieces can be engaged with the driving stub 73. A ratchet mechanism is located beside the driving member 71 and includes a pawl unit 74 which includes two pawl member 75, 76. Two springs 77 are biased between the two pawl members 75, 76 and an inner periphery of the hole of the head. A cam 8 is rotatably located between the two pawl members 75, 76 such that when rotating the cam 8, one of the two pawl members 75, 76 can be pushed away from the driving member 71 and the other pawl member 76 is pushed by the spring 77 and engaged with the teeth 72 of the driving member 71 to limit the direction of rotation of the driving member 71.

There are many parts, such as two pawl members 75, 76, two springs 77 and a cam 8, needed for a ratchet tool 7. In other words, it takes a lot of time to assemble the parts to be a ratchet tool 7.

The present invention intends to provide a ratchet mechanism for a ratchet tool wherein the ratchet mechanism is easily to be manufactured and assembled.

### SUMMARY OF THE INVENTION

The present invention relates to a ratchet tool which comprises a head and a handle connected to the head. A ratchet mechanism is received in a hole in the head and includes a driving member which includes teeth defined in an outer periphery thereof and a driving stub extends from a side of the driving member. A pawl is located beside the driving member and has a toothed surface. A selection member is pivotably connected to the head and connected to the pawl to engage the toothed surface with the driving member. A cover is mounted to the head and has an aperture through which the driving stub extends. A substantially U-shaped first spring member and a substantially U-shaped second spring member are respectively connected to the head, and each of the first and second spring members has a left biasing portion and a right biasing portion. The pawl is clamped between the left biasing portions and the right biasing portions.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a ratchet tool with the ratchet mechanism of the present invention;

FIG. 2 shows the engagement of the pawl and the spring members;

FIG. 3 shows another embodiment of the ratchet mechanism of the present invention;

FIG. 4 shows yet another embodiment of the ratchet mechanism of the present invention;

FIG. 5 shows that the beads are engaged with the positioning dimples wherein the pawl is positioned at a first position;

FIG. 6 shows that the beads are engaged with the positioning dimples wherein the pawl is positioned at a second position;

FIG. 7 is a side cross sectional view to show the ratchet mechanism in the ratchet tool, and

FIG. 8 shows a conventional ratchet mechanism for a ratchet tool.

### DETAILED DESCRIPTION OF THE PREFERRED EMBODIMENT

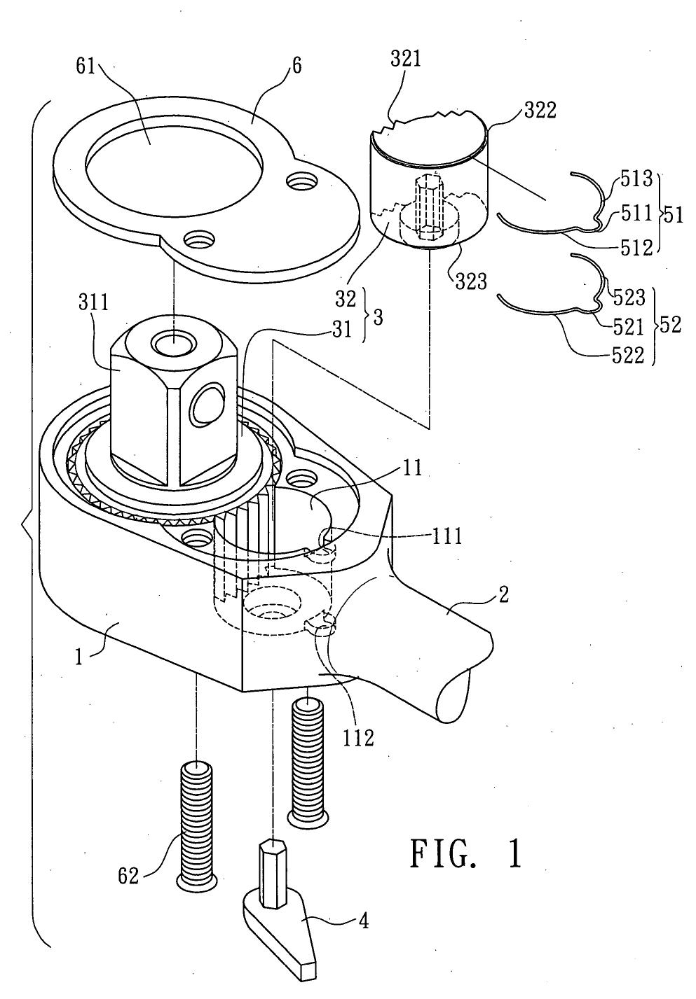

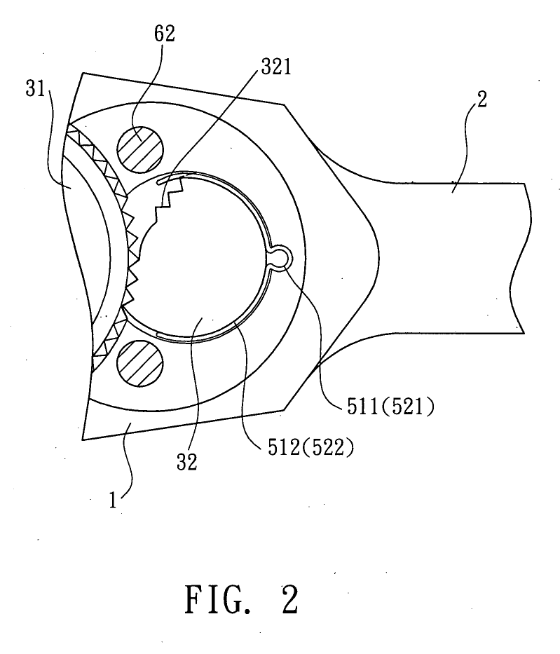

Referring to FIGS. 1 and 2, the ratchet tool of the present invention comprises a head 1 and a handle 2 connected to the head 1. A hole 11 is defined in the head 1 and a ratchet mechanism 3 is received in the hole 11. A first notch 111 and a second notch 112 are defined in an inner periphery of the hole 11.

The ratchet mechanism 3 includes a driving member 31 which includes teeth defined in an outer periphery thereof and a driving stub 311 extends from a side of the driving member 31. The driving stub 311 includes a rectangular cross section so as to be engaged with a socket or other parts. A pawl 32 is located beside the driving member 31 and includes a toothed surface 321 and a curved back which includes a first groove 322 and a second groove 323. A selection member 4 is pivotably connected to the head 1 and has a polygonal extension which is securely engaged with a polygonal recess defined in an underside of the pawl 32, such that the pawl 32 can be pivoted about an axis of the polygonal extension when the user pivoting the selection member 4. The toothed surface 321 of the pawl 32 is engaged with the teeth of the driving member 31. A cover 6 is fixedly mounted to the head 1 by using two bolts 62 extending through the head 1 and connected to two threaded holes in the cover 6. The cover 6 further has an aperture 61 through which the driving stub 311 extends.

A substantially U-shaped first spring member 51 and a substantially U-shaped second spring member 52 are respectively connected to the head 1. Each of the first and second spring members 51, 52 has a left biasing portion 512/522 and a right biasing portion 513/523. The first spring member 51 includes a first protrusion 511 which is connected between the left biasing portion 512 and the right biasing portion 513 of the first spring member 51, and the second spring member 52 includes a second protrusion 521 which is connected between the left biasing portion 522 and the right biasing portion 523 of the second spring member 52. The first and second protrusions 511, 521 are respectively engaged with the first and second notches 111, 112.

The first spring member 51 and the second spring member 52 are respectively engaged with the first and second grooves 322, 323, so that the curved back of the pawl 32 is clamped between the left biasing portions 512, 522 and the right biasing portions 513, 523.

When operating the selection member 4 to pivot the pawl 32 as shown in FIG. 2, the left biasing portions 512, 522 apply a force to engage the toothed surface 321 of the pawl 32 with the teeth of the driving member 31. The biasing members 51, 52 are easily to be manufactured and assembled such that the manufacturing cost is reduced.

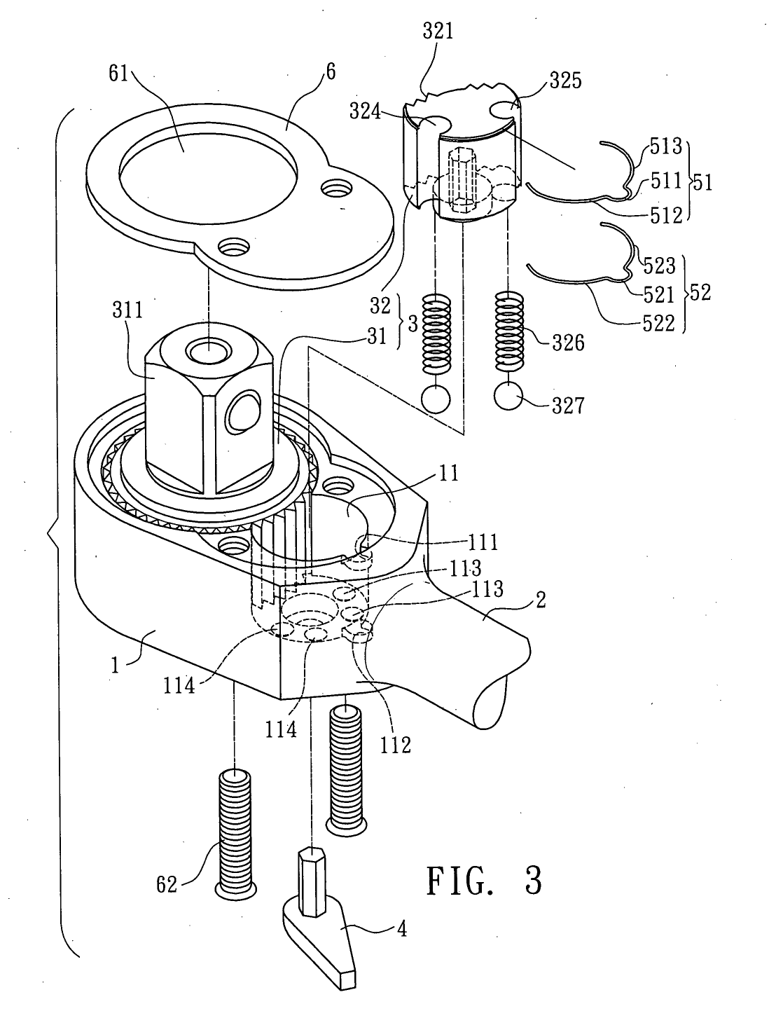

FIG. 3 shows another embodiment of the ratchet mechanism 3 wherein the pawl 32 includes two engaging slots 324, 325 defined axially therein and two springs 326 are engaged with the two engaging slots 324, 325. Two beads 327 are biased by the two springs 326. Two pairs of positioning dimples 113, 114 are defined in an inside of the head 1 so that the two beads 327 are engaged with two respective positioning dimples 113, 114 of the two pairs of the positioning dimples 113, 114 when operating the selection member 4. It is noted that the two biasing members 51 and 52 are installed to extend across the engaging slots 324, 325.

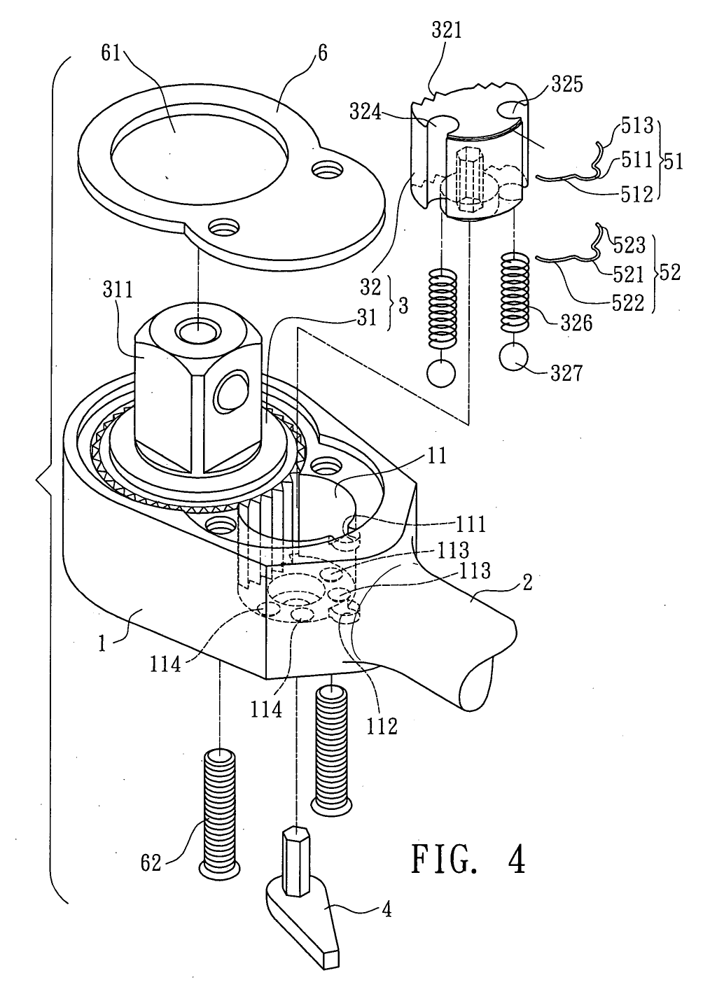

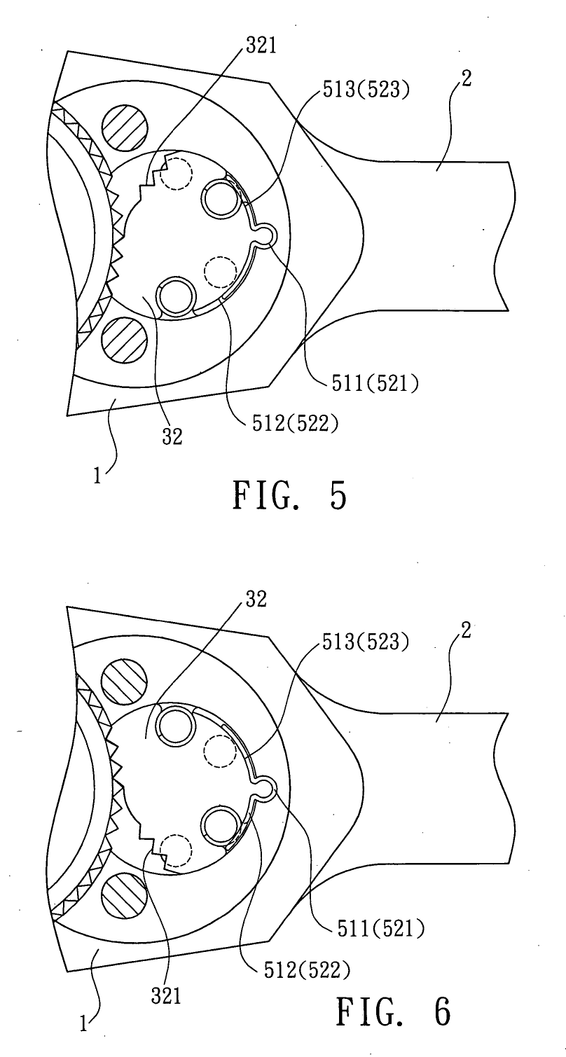

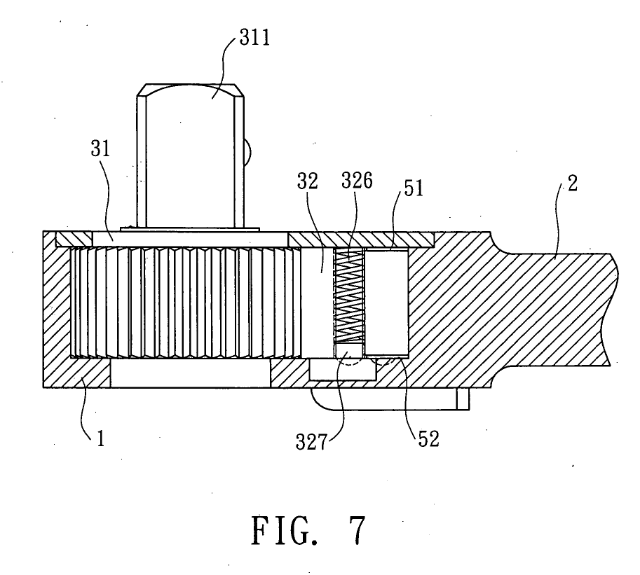

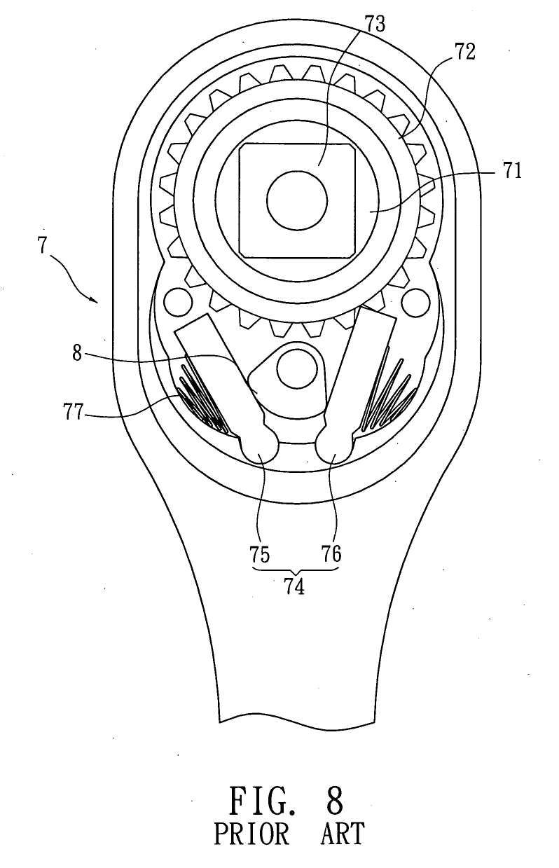

FIGS. 4 to 6 show yet another embodiment of the ratchet mechanism 3 and the only difference from the embodiment in FIG. 4 is that the first and second grooves 322, 323 and the first and second biasing members 51, 52 in FIG. 4 are shorter than those in FIG. 4. The biasing members 51, 52 do not go across the engaging slots 324, 325.

While we have shown and described the embodiment in accordance with the present invention, it should be clear to those skilled in the art that further embodiments may be made without departing from the scope of the present invention.

What is claimed is:

1. A ratchet tool comprising:
a head and a handle connected to the head, a hole defined in the head and a ratchet mechanism received in the hole, the ratchet mechanism including a driving member which includes teeth defined in an outer periphery thereof and a driving stub extending from a side of the driving member, a pawl located beside the driving member and having a toothed surface, a selection member pivotably connected to the head and connected to the pawl to engage the toothed surface with the driving member, a cover mounted to the head and having an aperture through which the driving stub extends, and
a substantially U-shaped first spring member and a substantially U-shaped second spring member respectively connected to the head, each of the first and second spring members having a left biasing portion and a right biasing portion, the pawl being clamped between the left biasing portions and the right biasing portions.

2. The ratchet tool as claimed in claim 1, wherein the pawl includes a curved back which includes a first groove and a second groove, the first spring member and the second spring member are respectively engaged with the first and second grooves.

3. The ratchet tool as claimed in claim 1, wherein first spring member includes a first protrusion which is connected between the left biasing portion and the right biasing portion of the first spring member, the second spring member includes a second protrusion which is connected between the left biasing portion and the right biasing portion of the second spring member, a first notch and a second notch are defined in an inner periphery of the hole, the first and second protrusions are respectively engaged with the first and second notches.

4. The ratchet tool as claimed in claim 1, wherein the pawl includes two engaging slots defined axially therein and two springs are engaged with the two engaging slots, two beads are biased by the two springs, two pairs of positioning dimples are defined in an inside of the head and the two beads are engaged with two respective positioning dimples of the two pairs of the positioning dimples.
